(19) United States
(12) Patent Application Publication
(10) Pub. No.: US 2026/0062000 A1
(43) Pub. Date: Mar. 5, 2026

(54) MULTI-DISTANCE GRID GENERATION FOR COMPUTER VISION

(71) Applicant: QUALCOMM Incorporated, San Diego, CA (US)

(72) Inventors: Simon Keisala, Linköping (SE); Andreas Sjadin Hallstrand, Linköping (SE)

(21) Appl. No.: 18/816,650

(22) Filed: Aug. 27, 2024

(51) Int. Cl. B60W 30/095; B60W 60/00

(52) U.S. Cl. CPC B60W 30/0956; B60W 60/0011; B60W 2420/403; B60W 2420/408

(57) ABSTRACT

A method for multi-distance computer vision includes obtaining sensor data generated by one or more sensors of a vehicle; generating a representation of at least a portion of a real-world environment surrounding the vehicle based on the sensor data, wherein the representation of the real-world environment surrounding the vehicle comprises a grid having a plurality of cells and wherein at least some of the plurality of cells simultaneously correspond to multiple real-world distances from the vehicle; using a plurality of object detectors for each of the plurality of cells, wherein each of the plurality of object detectors corresponds to a pre-defined real-world distance range from the vehicle; and controlling an operation of the vehicle using the representation and the plurality of object detectors.

### TECHNICAL FIELD

This disclosure relates to bird's eye view image content.

### BACKGROUND

An autonomous driving vehicle is a vehicle that is configured to sense the environment around the vehicle, such as the existence and location of other objects, and operating without human control. An autonomous driving vehicle may include a LiDAR (Light Detection and Ranging) system or other sensor system for sensing point cloud data indictive of the existence and location of other objects around the autonomous driving vehicle. In some examples, such an autonomous driving vehicle may be referred to as an ego vehicle. A vehicle having an advanced driver-assistance system (ADAS) is a vehicle that includes systems which may assist a driver in operating the vehicle, such as parking or driving the vehicle.

### SUMMARY

In general, this disclosure describes techniques for representing object existence at different distances within a single data structure. Traditionally, ADAS systems may use separate grids or maps to represent objects at different distances. This can be inefficient and cumbersome. The disclosed techniques use a single grid in a coordinate system (e.g., Cartesian or polar coordinate system) with multiple channels to represent object existence at different distances simultaneously. For example, the grid cells and depth bins may correspond to multiple distances simultaneously.

The aforementioned techniques that rely on a single grid system for all detection ranges may limit the ability to achieve both high spatial resolution for short distances and long detection range simultaneously. To address this problem, this disclosure further describes techniques that use a polar coordinate system with equi-areal discs representing different detection ranges. Each disc may cover a specific area around the vehicle. Unlike a single Cartesian grid techniques, the polar coordinates techniques allow adding new discs with larger radii to extend the detection range as needed. By adjusting the size and number of discs, the spatial resolution may be tailored within specific ranges. Smaller discs closer to the vehicle may provide higher resolution for detailed object detection, while larger discs may cover wider areas for long-range detection. Both techniques use a single model with multiple channels (one for each disc). This maintains computational efficiency compared to alternative approaches requiring multiple models.

In one example, a method for sensing includes obtaining sensor data generated by one or more sensors of a vehicle; generating a representation of at least a portion of a real-world environment surrounding the vehicle based on the sensor data, wherein the representation of the real-world environment surrounding the vehicle comprises a grid having a plurality of cells and wherein a first cell of the plurality of cells corresponds to a first real-world distance between the real-world environment and the vehicle and a second real-world distance between the real-world environment and the vehicle, and wherein at least a second cell of the plurality of cells corresponds to a third real-world distance between the real-world environment and the vehicle and a fourth real-world distance between the real-world environment and the vehicle; using a plurality of object detectors for each of the plurality of cells, wherein each of the plurality of object detectors corresponds to a pre-defined real-world distance range from the vehicle; and controlling an operation of the vehicle using the representation and the plurality of object detectors.

In another example, an apparatus for sensing includes a memory for storing sensor data; and processing circuitry in communication with the memory. The processing circuitry is configured to obtain the sensor data generated by one or more sensors of a vehicle. The processing circuitry is also configured to generate a representation of at least a portion of a real-world environment surrounding the vehicle based on the sensor data, wherein the representation of the real-world environment surrounding the vehicle comprises a grid having a plurality of cells and wherein a first cell of the plurality of cells corresponds to a first real-world distance between the real-world environment and the vehicle and a second real-world distance between the real-world environment and the vehicle, and wherein at least a second cell of the plurality of cells corresponds to a third real-world distance between the real-world environment and the vehicle and a fourth real-world distance between the real-world environment and the vehicle; and use a plurality of object detectors for each of the plurality of cells, wherein each of the plurality of object detectors corresponds to a pre-defined real-world distance range from the vehicle. The processing circuitry is further configured to control an operation of the vehicle using the representation and the plurality of object detectors.

In yet another example, non-transitory computer-readable storage media having instructions encoded thereon, the instructions configured to cause processing circuitry to: obtain sensor data generated by one or more sensors of a vehicle. Additionally, the instructions are configured to cause the processing circuitry to generate a representation of at least a portion of a real-world environment surrounding the vehicle based on the sensor data, wherein the representation of the real-world environment surrounding the vehicle comprises a grid having a plurality of cells and wherein a first cell of the plurality of cells corresponds to a first real-world distance between the real-world environment and the vehicle and a second real-world distance between the real-world environment and the vehicle, and wherein at least a second cell of the plurality of cells corresponds to a third real-world distance between the real-world environment and the vehicle and a fourth real-world distance between the real-world environment and the vehicle wherein at least some of the plurality of cells simultaneously correspond to multiple real-world distances from the vehicle; and to use a plurality of object detectors for each of the plurality of cells, wherein each of the plurality of object detectors corresponds to a pre-defined real-world distance range from the vehicle. Furthermore, the instructions are configured to cause the processing circuitry to control an operation of the vehicle using the representation and the plurality of object detectors.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example autonomous vehicle, in accordance with the techniques of this disclosure.

FIG. 2 is a block diagram illustrating an example computing system that may perform the techniques of this disclosure.

FIG. 3 is a diagram illustrating an example Bird's-Eye View (BEV) representation generated by an example perception model.

FIG. 4 is a diagram illustrating an example grid generated by an example perception model in accordance with the techniques of this disclosure.

FIG. 5 is a diagram illustrating an angular error in accordance with the techniques of this disclosure.

FIG. 6 is a diagram illustrating misalignment issues of a Cartesian grid in accordance with the techniques of this disclosure.

FIG. 7 illustrates that in a Cartesian system shrinking one dimension of a cell while maintaining the other may create discontinuity at the boundary between short-range and long-range detection areas in accordance with the techniques of this disclosure.

FIG. 8A is a diagram illustrating representation of detection areas using a polar coordinate system in accordance with techniques of this disclosure.

FIG. 8B is a diagram illustrating collapsing a representation of a detection area to a single point in accordance with techniques of this disclosure.

FIG. 9 is a diagram of extendable detection range in accordance with the techniques of this disclosure.

FIG. 10 is a flowchart illustrating an example method for sensing in accordance with the techniques of this disclosure.

### DETAILED DESCRIPTION

ADAS systems use a combination of sensors (cameras, radar, LiDAR) and software to enhance a driver's awareness and improve vehicle safety. The example techniques are described with respect to ADAS for ease, but may be applicable to other systems as well, including generally to computer vision systems, such as in robotics.

Perception models are the initial processing stage in computer vision tasks for autonomous vehicles. Perception models focus on extracting essential information from sensor data, such as cameras and LiDAR, to understand the surrounding environment. Lift-Splat-Shoot (LSS) is a neural network architecture commonly used by ADAS systems for three dimensional (3D) scene understanding.

Lift stage might involve processing the sensor data to elevate 2D sensor data into a 3D space. The lift stage may extract features from sensors (cameras, LiDAR, etc.). The lift stage may project these features into a 3D coordinate system using sensor calibration information. The lift stage may create a “feature-filled point cloud” where each point represents a feature and its 3D location. Splat stage might reduce 3D point cloud to a 2D BEV representation. The splat stage may define a BEV grid with specific resolution (x, z dimensions). The splat stage may project each 3D point onto the corresponding grid cell based on its x and z coordinates. The splat stage may further aggregate feature information within each grid cell. Shoot stage is not directly involved in BEV creation, but may utilize the BEV for planning. The shoot stage may use the generated BEV to plan vehicle trajectories and actions. The lift stage is about creating a rich 3D representation of the environment. The splat stage collapses this 3D information into a top-down view for efficient processing. The shoot stage leverages the BEV for decision-making and control.

Image view refers to the raw perspective captured by the camera, which is a 2D representation of the 3D world. Bird's-Eye View (BEV) is a top-down, flattened representation of the scene, often used in autonomous driving as BEV provides a more comprehensive understanding of the surroundings. By leveraging the LSS-like architecture, ADAS system extracts informative features (like edges, corners) from the camera image. ADAS system may utilize calibration information (camera parameters) to project these features onto a virtual 3D world space. This creates a preliminary understanding of the scene in 3D. Refinement stage might involve further processing to refine the 3D representation based on additional sensor data (e.g., LiDAR data) or constraints from the driving environment.

The BEV representation provides several advantages for automotive image detection. The BEV representation allows the ADAS system to understand the relative positions and distances of objects in the scene, which is important for tasks like obstacle detection and path planning. The BEV representation can simplify object detection algorithms as objects often appear more distinct and easier to localize from a top-down perspective. ADAS system may discretize the area around the vehicle by generating a grid-like data structure surrounding the vehicle. Each cell in this grid may represent a specific volume or region in the 3D space around the vehicle. Assigning a distance value to each grid cell allows the ADAS system to understand how far away each region is from the vehicle. One of the benefits of using a BEV representation for perception tasks is its ability to seamlessly fuse data from multiple sensors. This may be particularly important for accurate and robust object detection. By combining information from cameras, LiDAR, radar, and other sensors into a unified BEV representation, the ADAS system may leverage the strengths of each sensor modality. Cameras may excel at providing rich semantic information about objects, such as color, texture, and shape. LiDAR may offer precise 3D spatial information, including, but not limited to, distance, height, and object dimensions. Radar may provide reliable detection in adverse weather conditions and long-range object information. By merging these diverse data sources in the BEV space, the ADAS may create a more comprehensive and accurate understanding of the environment. This merging of diverse data sources may be especially beneficial for challenging scenarios, such as, but not limited to, occlusions, large objects, and adverse weather conditions. When objects are partially or fully obscured by other objects, combining information from multiple sensors may help the ADAS system to fill in missing data and improve detection accuracy. Vehicles like trucks or buses may extend across multiple camera views. A BEV representation may effectively capture the entire object, enhancing detection and tracking performance. Radar data may complement camera and LiDAR information in challenging weather conditions, improving overall system robustness.

An ADAS may take 2D features extracted from the camera image (e.g., edges, corners). ADAS system may project each feature along a virtual ray cast from the position of the camera towards the scene. This projection may essentially “lift” the feature out into the 3D world, taking into account the perspective of the camera. For example, ADAS system may divide each ray into D segments, with each segment representing a specific distance from the camera. So, for each image feature, the ADAS may essentially create D copies and may place them at these D discrete locations along the projected ray.

As used herein, D′ denotes a specific depth value within the D discrete locations mentioned earlier. After projecting the image feature to D locations, the ADAS may perform a probability estimation for each location. The disclosed process may bridge the gap between the 2D image data captured by the camera and the 3D world surrounding the vehicle. By projecting image features and estimating their probabilities at different depths, the ADAS may build a 3D understanding of the environment. The information about the environment may be used for various tasks, such as, but not limited to: object detection, depth estimation, path planning. Object detection may involve identifying the presence and location of objects like pedestrians, vehicles, and traffic signs. Depth estimation may involve understanding the relative distances of objects from the vehicle. Path planning may involve determining safe and efficient navigation paths for the autonomous vehicle. Discretizing space and using multiple depths allows for a more accurate representation of the 3D world compared to a single depth estimation.

Probability estimation may help the ADAS system deal with uncertainties and noise in the data. While the disclosed techniques discretize the space around the vehicle, they do not directly create a BEV representation. BEV is a top-down flattened view, whereas the disclosed techniques focus on individual rays projected from the camera. However, the information obtained through depth estimation at different locations may be used as building blocks for constructing a BEV representation in later stages of the processing pipeline of the ADAS.

Choosing the size of grid cells and the number of discrete distances (D) for image feature projection may involve a trade-off between several factors in an object detection system of ADAS. In other words, choosing smaller grid cells may create a finer-grained representation of the 3D space. Smaller grid cells may allow for more precise object detection, potentially enabling the model to distinguish between objects that are very close together. With a finer grid, the total area covered by the grid may be limited. The ADAS may struggle to detect objects at larger distances from the vehicle.

A finer grid may require more computations for ray casting, depth estimation, and network processing. A finer grid may increase the processing power needed for real-time object detection.

A coarser grid may cover a larger area, potentially allowing the ADAS to detect objects farther away from the vehicle. In this case, fewer grid cells may translate to less processing needed for ray casting, depth estimation, and network operation. The ADAS may struggle to differentiate between closely spaced objects due to the less precise representation of the 3D space. The hyperparameter D (number of discrete distances) may control the number of locations along each ray cast from the camera at which the model performs probability estimation. A higher number of discrete distances may allow for more accurate depth estimation, potentially reducing localization errors.

However, similar to smaller grid cells, a higher D value may increase the computational cost due to the need for more probability estimations. The ideal configuration may depend on various factors specific to ADAS system, such as, but not limited to: sensor capabilities, computational resources and environmental considerations. The resolution and range of the camera and LiDAR sensors may influence the optimal grid size and D value. The processing power available on the hardware of the vehicle may limit how fine-grained the grid and D can be. In dense urban environments, finer detection may be necessary, whereas on highways, a larger detection distance may be more important.

Often, engineers will experiment with different grid sizes and D values to find a balance that achieves good detection accuracy within the processing power constraints of the system. In one example, the grid size may be adaptive. In other words, the grid size can vary depending on the region of interest (e.g., finer grid near the vehicle, coarser grid further away).

Increasing the maximum detection distance (“D”) for the furthest depth bin may come at a cost. Increasing the spacing between depth bins, may lead to lower depthwise resolution. The increased spacing between depth bins may make it harder to accurately localize objects, especially at longer distances where details become finer. Increasing the total number of depth bins may result in higher computational cost. The increased total number of depth bins may push the model beyond the real-time processing capabilities of the hardware. For example, reducing depthwise resolution by half to achieve 100 m detection range could significantly affect performance. The ADAS may struggle to distinguish between closely spaced objects at longer distances due to the loss of detail in the depth information. The best solution may depend on a variety of factors specific to ADAS system, such as, but not limited to, budget constraints, sensor capabilities, and the specific performance requirements for long-range object detection.

The solution may be a trade-off between achieving the desired detection range, maintaining good object localization accuracy, and ensuring real-time processing on the available hardware. The ADAS system may potentially detect vehicles up to 100 meters away from the ego vehicle in a radius around it.

To address the aforementioned limitations of the current systems the disclosed techniques use a single grid in a coordinate system (e.g., Cartesian or polar coordinate system) with multiple channels to represent object existence at different distances simultaneously. For example, the grid cells and depth bins may correspond to multiple distances simultaneously, as described in greater details below.

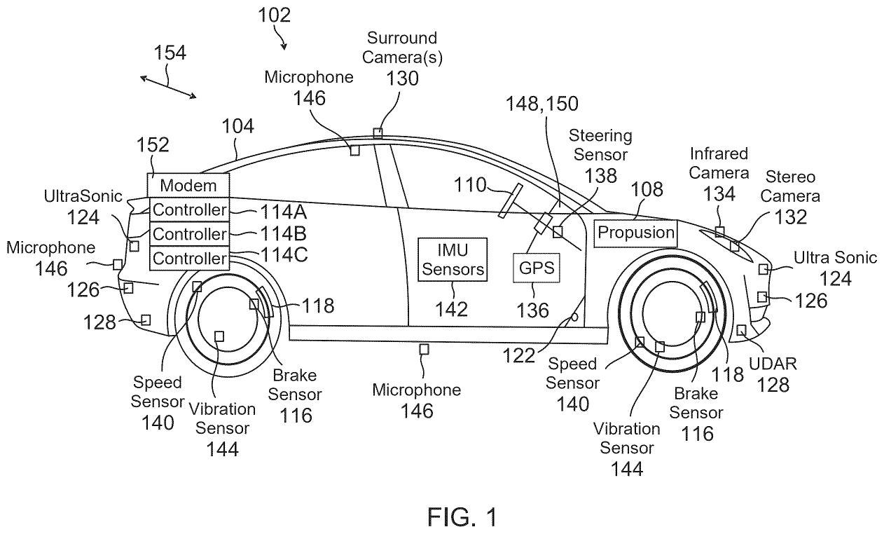

FIG. 1 shows an example vehicle 102. Vehicle 102 in the example shown may comprise a passenger vehicle such as a car or truck that can accommodate a human driver and/or human passengers. In an aspect, vehicle 102 may comprise an autonomous vehicle, semi-autonomous vehicle and/or an ADAS system. Vehicle 102 may include a vehicle body 104 suspended on a chassis, in this example comprised of four wheels and associated axles. A propulsion system 108 such as an internal combustion engine, hybrid electric power plant, or even all-electric engine may be connected to drive some or all of the wheels via a drive train, which may include a transmission (not shown). A steering wheel 110 may be used to steer some or all of the wheels to direct vehicle 102 along a desired path when the propulsion system 108 is operating and engaged to propel the vehicle 102. Steering wheel 110 or the like may be optional for Level 5 implementations. One or more controllers 114A-114C (a controller 114) may provide autonomous capabilities in response to signals continuously provided in real-time from an array of sensors, as described more fully below.

Each controller 114 may be essentially one or more onboard computers that may be configured to perform deep learning and/or artificial intelligence functionality and output autonomous operation commands to self-drive vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide artificial intelligence functionality for in-camera sensors, and controller 114D (not shown) may provide infotainment functionality and provide additional redundancy for emergency situations.

Controller 114 may send command signals to operate vehicle brakes 116 via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”)—a network inside modern cars used to control brakes, acceleration, steering, windshield wipers, and the like. The CAN bus may be configured to have dozens of nodes, each with its own unique identifier (CAN ID). The bus may be read to find steering wheel angle, ground speed, engine RPM, button positions, and other vehicle status indicators. The functional safety level for a CAN bus interface is typically Automotive Safety Integrity Level (ASIL) B. Other protocols may be used for communicating within a vehicle, including FlexRay and Ethernet.

In an aspect, an actuation controller may be obtained with dedicated hardware and software, allowing control of throttle, brake, steering, and shifting. The hardware may provide a bridge between the vehicle's CAN bus and the controller 114, forwarding vehicle data to controller 114 including the turn signal, wheel speed, acceleration, pitch, roll, yaw, Global Positioning System (“GPS”) data, tire pressure, fuel level, sonar, brake torque, and others. Similar actuation controllers may be configured for any other make and type of vehicle, including special-purpose patrol and security cars, robo-taxis, long-haul trucks including tractor-trailer configurations, tiller trucks, agricultural vehicles, industrial vehicles, and buses.

Controller 114 may provide autonomous driving outputs in response to an array of sensor inputs including, for example: one or more ultrasonic sensors 124, one or more RADAR sensors 126, one or more LiDAR sensors 128, one or more surround cameras 130 (typically such cameras are located at various places on vehicle body 104 to image areas all around the vehicle body), one or more stereo cameras 132 (in an aspect, at least one such stereo camera may face forward to provide object recognition in the vehicle path), one or more infrared cameras 134, GPS unit 136 that provides location coordinates, a steering sensor 138 that detects the steering angle, speed sensors 140 (one for each of the wheels), an inertial sensor or inertial measurement unit (“IMU”) 142 that monitors movement of vehicle body 104 (this sensor can be for example an accelerometer(s) and/or a gyro-sensor(s) and/or a magnetic compass(es)), tire vibration sensors 144, and microphones 146 placed around and inside the vehicle. Other sensors may be used, as is known to persons of ordinary skill in the art.

Controller 114 may also receive inputs from an instrument cluster 148 and may provide human-perceptible outputs to a human operator via human-machine interface (“HMI”) display(s) 150, an audible annunciator, a loudspeaker and/or other means. In addition to traditional information such as velocity, time, and other well-known information, HMI display 150 may provide the vehicle occupants with information regarding maps and vehicle's location, the location of other vehicles (including an occupancy grid) and even the Controller's identification of objects and status. For example, HMI display 150 may alert the passenger when the controller has identified the presence of a stop sign, caution sign, or changing traffic light and is taking appropriate action, giving the vehicle occupants peace of mind that the controller 114 is functioning as intended.

In an aspect, instrument cluster 148 may include a separate controller/processor configured to perform deep learning and artificial intelligence functionality.

Vehicle 102 may collect data that is preferably used to help train and refine the neural networks used for autonomous driving. The vehicle 102 may include modem 152, preferably a system-on-a-chip that provides modulation and demodulation functionality and allows the controller 114 to communicate over the wireless network 154. Modem 152 may include an RF front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: LTE, WCDMA, UMTS, GSM, CDMA2000, or other known and widely used wireless protocols.

It should be noted that, compared to sonar and RADAR sensors 126, cameras 130-134 may generate a richer set of features at a fraction of the cost. Thus, vehicle 102 may include a plurality of cameras 130-134, capturing images around the entire periphery of the vehicle 102. Camera type and lens selection depends on the nature and type of function. The vehicle 102 may have a mix of camera types and lenses to provide complete coverage around the vehicle 102; in general, narrow lenses do not have a wide field of view but can see farther. All camera locations on the vehicle 102 may support interfaces such as Gigabit Multimedia Serial link (GMSL) and Gigabit Ethernet.

In an aspect, a controller 114 may obtain sensor data generated by one or more sensors 128-134 of the vehicle 102. Next, controller 114 may generate a representation of at least a portion of a real-world environment surrounding the vehicle based on the sensor data. The representation of the real-world environment surrounding the vehicle may include a grid having a plurality of cells. At least some of the plurality of cells may simultaneously correspond to multiple real-world distances from the vehicle, as described in more detail below. Next, controller 114 may use a plurality of object detectors for each of the plurality of cells. Each of the plurality of object detectors may correspond to a pre-defined real-world distance range from the vehicle. Finally, controller 114 may control an operation of the vehicle using the representation and the plurality of object detectors.

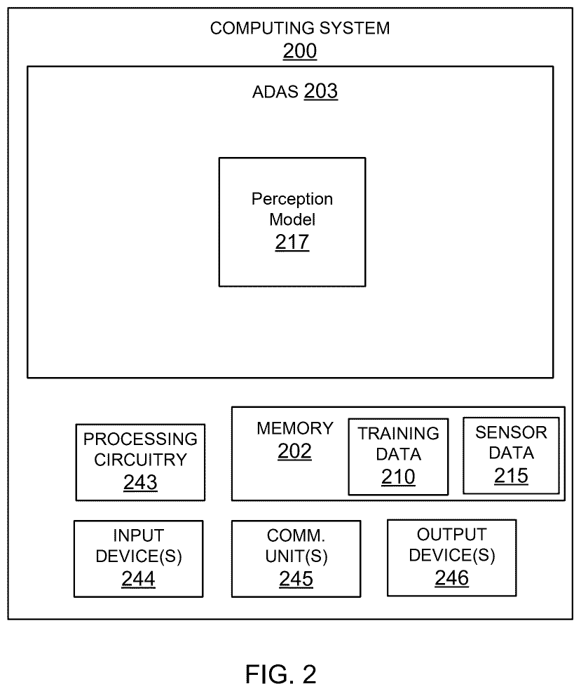

FIG. 2 is a block diagram illustrating an example computing system that may perform the techniques of this disclosure. As shown, computing system 200 comprises processing circuitry 243 and memory 202 for executing ADAS 203, which may represent an example instance of any controller 114 described in this disclosure, such as controller 114 of FIG. 1.

Computing system 200 may be implemented as any suitable external computing system accessible by controller 114, such as one or more server computers, workstations, laptops, mainframes, appliances, embedded computing systems, cloud computing systems, High-Performance Computing (HPC) systems (i.e., supercomputing systems) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. In an aspect, computing system 200 is disposed in vehicle 102.

For example, from perspective of training a model, computing system 200 may be part of a cloud computing system. From perspective of run-time, computing system 200 may be part of a vehicle.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 200 comprises any suitable computing system having one or more computing devices, such as desktop computers, laptop computers, gaming consoles, smart televisions, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network—PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more aspects of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random-access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable read only memories (EPROM) or electrically erasable and programmable (EEPROM) read only memories.

Memory 202 may store program instructions and/or data associated with one or more of the modules described in accordance with one or more aspects of this disclosure. For example, memory 202 may store multi-modal input data 215 received from one or more sensors 128-134 of the vehicle 102 and training data 210. Training data 210 may include data that may be used for training perception model 217, such as but not limited to, ground truth data described in greater detail below.

Processing circuitry 243 and memory 202 may provide an operating environment or platform for one or more modules or units (e.g., ADAS 203, including perception model 217, etc.), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute ADAS 203, including perception model 217, using virtualization modules, such as a virtual machine or container executing on underlying hardware. One or more of such modules may execute as one or more services of an operating system or computing platform. Aspects of ADAS 203 may execute as one or more executable programs at an application layer of a computing platform.

One or more input device(s) 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output device(s) 246 may generate, transmit, or process output. Examples of output are tactile, audio, visual, and/or video output. Output devices 246 may include a display, sound card, video graphics adapter card, speaker, presence-sensitive screen, one or more universal serial bus (USB) interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, 5G and Wi-Fi® radios found in mobile devices as well as Universal Serial Bus (USB) controllers and the like.

In the example of FIG. 2, ADAS 203 may rely on various sensors to gather information about the surroundings of the vehicle 102. These can include cameras 130-134, RADAR sensors 126, LiDAR sensors 128, as described herein. ADAS 203 may receive input data. The input data and output data may contain various types of information. For example, the input data may include, but is not limited to, multi-modal camera/LiDAR data. The output data may include generated Cartesian grid, existence probabilities, bounding boxes, equi-areal discs representing different detection ranges and so on. The output data may be used by one or more of object detection unit, depth estimation unit, and path planning unit.

As noted above, in one non-limiting example, the ADAS system 203 may potentially detect vehicles up to 100 meters away from the vehicle 102 in a radius around it. In one example, the environment around the vehicle 102 may be discretized into a relatively high-resolution grid of 256×256 cells. Such grid resolution may allow for a detailed representation of the scene. A relatively high-resolution grid of 256×256 cells is provided for example purposes only, and should not be considered limiting.

The ADAS system 203 may utilize 128 discrete depth bins for image feature projection. Having 128 discrete depth bins is provided for purposes of example only, and should not be considered limiting. Having 128 discrete depth bins may provide a good level of granularity for estimating the distance of objects within the 100-meter range. In one example, the ADAS system 203 may predict various properties for each detected vehicle, including, but not limited to: existence probability, 3D bounding box and orientation. The term “existence probability,” as used herein, refers to the likelihood that a vehicle actually exists in a particular grid cell. In another example, the ADAS system 203 may predict the location and size of each detected vehicle in 3D space, likely represented by four values (e.g., length, width, height, and center coordinates), The ADAS system 203 may predict the roll, pitch, and yaw angles of each detected vehicle, indicating its rotation along different axes. While the chosen grid resolution and depth bins seem manageable, predicting 8 channels of output information (existence probability, 3D bounding box, and orientation) for each cell in a 256×256 grid may still be computationally expensive. Depending on the hardware platform, achieving real-time performance (processing frames fast enough for autonomous driving) may require further optimization.

At least in some cases, the ADAS system 203 may struggle with vehicles that are partially or completely occluded by other objects (e.g., trees, buildings). Generally, the ADAS system 203 may be well-equipped for vehicle detection within a 100-meter radius with good resolution and depth perception capabilities. However, it may be important to consider the computational cost of processing the high-resolution grid and the challenges of handling occlusions to ensure real-time performance and robust object detection in various driving scenarios.

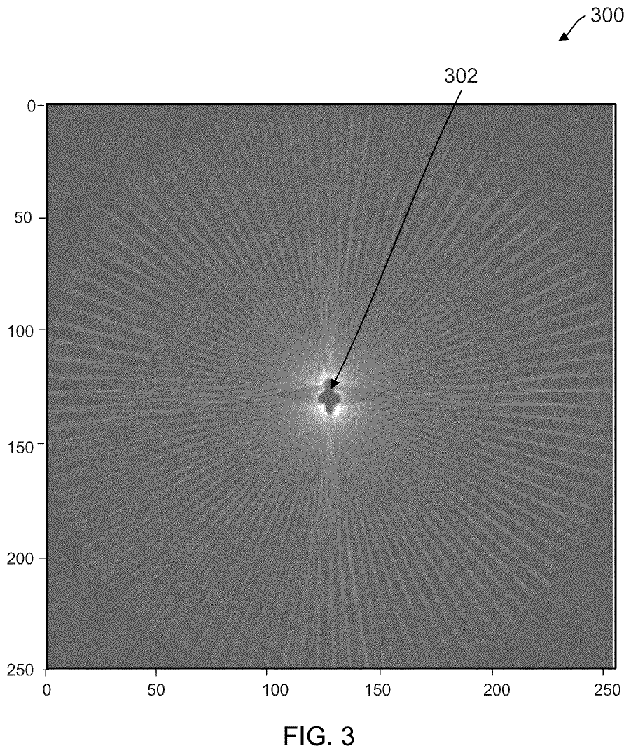

FIG. 3 is a diagram illustrating an example Bird's-Eye View (BEV) representation 300 generated by an example perception model. In an example, perception model 217 may have an LSS-like architecture, which may involve, but is not limited to: feature extraction and splatting. Feature extraction may involve extracting informative features (edges, corners) from the images captured by the vehicle's cameras 130-134. In one example, splatting may involve projecting these features onto a virtual 3D world space, essentially converting the information from a 2D perspective to a top-down BEV representation 300. In some examples, the perception model 217 itself may not explicitly encode real-world distances into the BEV grid. Instead, the perception model 217 may create a grid with a certain number of cells, and the distance between each cell may correspond to in real life may be defined during the process of generating ground truth data. In one example, the perception model 217 may have a pre-defined scale that maps each cell in the BEV grid to a specific distance from the vehicle 102 (e.g., 1 cell=1 meter). The BEV grid may be an abstraction in creating a top-down view of the 3D world. The BEV grid may be a 2D grid superimposed on the ground plane, with each cell representing a specific area in the real world. The resolution (distance between cells) may be an important parameter that determines the level of detail captured in the BEV representation. Traditionally, there is a direct correspondence between the x-y coordinates of the BEV grid and the real-world x-y coordinates. This rigid mapping may limit flexibility and accuracy. For instance, if the position of the vehicle changes, the entire BEV grid may need to be recalculated. The disclosed techniques may decouple the BEV grid from the world space coordinates. By allowing for a non-linear transformation between the two spaces, the disclosed techniques may provide several potential advantages. The perception model 217 may adapt the BEV grid to focus on specific regions of interest, such as the area immediately around the vehicle 102. By introducing a more flexible mapping, the perception model 217 may potentially improve the accuracy of object localization and tracking in the BEV space. By focusing the BEV grid on relevant areas, the perception model 217 may reduce computational costs.

In one scenario, when creating labeled training data, trainers may annotate the location of vehicles within the BEV grid based on their actual distance from the vehicle 102, using this pre-defined scale. During inference (when the perception model 217 makes predictions on real-world data), the perception model 217 may output information like existence probability and bounding boxes for each cell in the BEV grid. In one example, to determine the actual distance of a detected vehicle from the ego vehicle 102, the ADAS 203 may take the predicted location of the vehicle within the BEV grid. The ADAS 203 may apply the pre-defined scale used for ground truth generation. This may translate the cell position back into a real-world distance. Separating distance encoding from the perception model 217 may offer flexibility. Users may adjust the scale (meters per cell) without retraining the perception model 217 itself as long as the ground truth data is labeled accordingly. The perception model 217 may potentially be applied to vehicles with different sensor configurations (varying camera placements or resolutions) as long as the BEV grid and distance encoding are adjusted accordingly.

The image 300 shows a BEV representation where the area around the vehicle 302 (e.g., vehicle 102 in FIG. 1) may be divided into a 256×256 grid of cells. This discretization allows for efficient processing and localization of objects within the scene. Each ray cast from the cameras of the vehicle 302 may be further discretized into 128 depth bins. This essentially may create a series of virtual “slices” along the ray, allowing the perception model 217 to capture information at various distances.

It should be noted that nowhere in this BEV representation is there an explicit encoding of real-world distances for each cell or depth bin; however, inclusion of real-world distances may be possible. In other words, the perception model 217 may operate on a relative scale, in some examples. For instance, in some examples, the perception model 217 may have no information about how many meters a specific cell or depth bin corresponds to in the real world. The actual distance information may be introduced during the process of generating ground truth data for training the perception model 217. When creating labeled training data 210, a pre-defined scale that maps each cell in the BEV grid and each depth bin to a specific real-world distance (e.g., 1 cell=1 meter, 1 depth bin=0.5 meters) may be used. The location of vehicles within the BEV grid and depth bins may be annotated based on their actual distance from the vehicle 302, using this pre-defined scale. During inference, the perception model 217 may make predictions on real-world data. Perception model 217 may output information like existence probability and bounding boxes for each cell in the BEV grid. To determine the actual distance of a detected vehicle from the vehicle 302, ADAS system 203 may take the predicted location (cell and depth bin) of the vehicle. ADAS system 203 may apply the pre-defined scale that was used for ground truth generation. This operation may translate the cell and depth bin position back into a real-world distance (meters). Separating distance encoding from the perception model 217 may offer significant advantages. The scale (meters per cell/depth bin) may be adjusted without retraining the perception model 217 itself as long as the ground truth data is labeled accordingly. This flexibility may allow for adaptation to different sensor configurations or environments. The perception model 217 may potentially be applied to vehicles with varying camera placements or resolutions as long as the BEV grid, depth binning, and distance encoding are adjusted accordingly in the training data 210.

In one non-limiting example, the ADAS system 203 may potentially detect pedestrians up to 100 meters away from the vehicle 302 in a radius around it. The environment may be discretized into a relatively high-resolution grid of 256×256 cells, covering the entire 100-meter radius. Such grid may allow for detailed representation of the scene.

The ADAS system 203 may utilize 128 depth bins for image feature projection, providing good granularity for estimating the distance of pedestrians within the 100-meter range. The perception model 217 may predict various properties for each detected pedestrian, including, but not limited to: existence probability, 3D bounding box, walking direction and head direction. Existence probability may indicate the likelihood that a pedestrian exists in a particular grid cell. The 3D bounding box may indicate the location and size of the pedestrian in 3D space, likely represented by four values (e.g., length, width, height, and center coordinates). The walking direction and head direction may provide valuable information for understanding pedestrian behavior and predicting their movements. Predicting 11 channels of output information (e.g., existence probability, 3D bounding box, walking direction, head direction, etc.) for each cell in a 256×256 grid may be computationally expensive. Depending on the hardware platform of the ADAS 203, achieving real-time performance (processing frames fast enough for autonomous driving) may require further optimization. The ADAS system 203 may struggle with pedestrians that are partially or completely occluded by other objects (e.g., trees, poles). A 256×256 grid covering 100 meters may not capture very detailed information about pedestrians, especially at longer distances. The size of a pedestrian cell may be too large to accurately determine walking direction or head pose.

Continuing with the aforementioned example, with a 100-meter coverage and 256 cells, each cell may correspond to an area of roughly 0.8×0.8 meters. Similarly, the depth resolution may be 0.78 meters per bin.

In other words, if multiple pedestrians are standing close together (within the same cell area), the ADAS system 203 may struggle to distinguish them as separate objects. This limitation may be particularly problematic in crowded city environments where pedestrians are often in close proximity. The perception model 217 may miss pedestrians altogether or inaccurately predict a single bounding box for multiple pedestrians occupying the same cell.

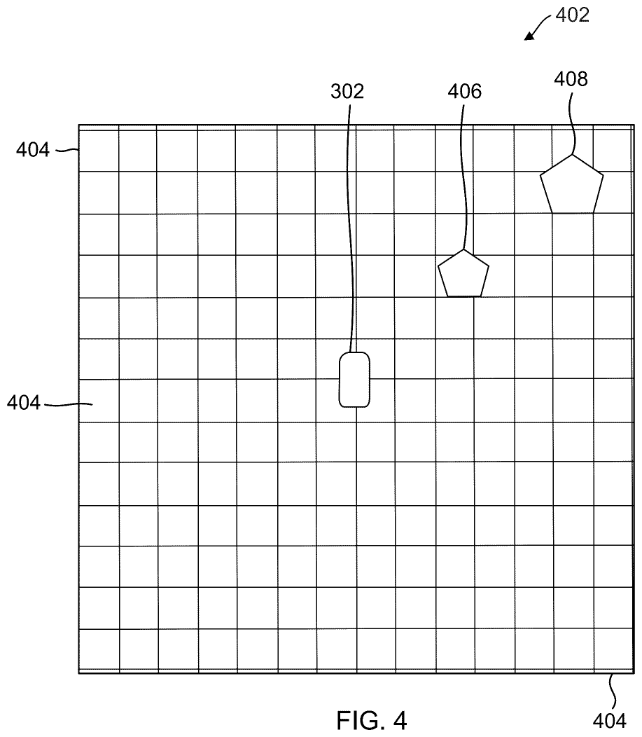

FIG. 4 is a diagram illustrating an example grid generated by an example perception model in accordance with the techniques of this disclosure. The disclosed techniques deviate from the traditional approach where each cell and depth bin corresponds to a single distance. Instead, the disclosed techniques use a grid 402 and depth bins that may encode information for multiple distances simultaneously. In the example illustrated in FIG. 4, ADAS 203 may simply consider two distances: “short-range” and “long-range.” This may translate to having two channels or two sets of channels in the output grid. A short range existence channel may predict the likelihood of a pedestrian existing within the cell at a distance closer to the vehicle 302 (potentially within the first half of the 100-meter range). A long range existence channel may predict the likelihood of a pedestrian existing within the cell at a distance further from the vehicle 302 (potentially within the second half of the 100-meter range). By encoding information for multiple distances within each cell 404, the perception model 217 may potentially detect pedestrians even if they are close together. The “short-range existence” channel may identify pedestrians within the same cell that might be missed by a single-distance approach.

For example, there may be no need to increase the grid resolution as drastically compared to a single-distance approach. Even with the current 256×256 grid 402, the perception model 217 may potentially differentiate between closely spaced pedestrians by analyzing both existence channels. The disclosed techniques require modifying the model architecture to handle the additional channels and potentially learn the relationship between short-range and long-range existence probabilities within each cell 404. Generating training data 210 for this technique may be more complex. An annotator may need to annotate pedestrian locations not just with a single distance but potentially with labels indicating whether they are short-range or long-range within each cell 404. In some cases, there may be ambiguity, especially at the boundary between short and long range. The perception model 217 may struggle to definitively assign existence probability to one channel or the other.

While FIG. 4 showcases a simplified example with two distances, the concept could be extended to encode information for even more distance ranges within each cell and depth bin. Using more than 2 distances could provide even finer-grained information but would further increase model complexity.

The ADAS 203 may create two separate ground truth maps for “short-range existence” and “long-range existence” channels in the output grid 402. For the short-range existence map, ADAS system 203 may label the ground truth as if each cell 404 corresponded to a 0.5-meter distance resolution. For the long-range existence map, the ADAS 203 may label the ground truth as if each cell 404 corresponded to a 1-meter distance resolution. The disclosed technique may essentially duplicate the location of a pedestrian in the ground truth data for perception model 217. The same pedestrian may be marked in two locations within the same cell 404. First mark (long-range) 406 in FIG. 4 may indicate a high probability of the pedestrian existing in the cell at a distance closer to 1 meter (based on the long-range map). Second mark (short-range) 408 may indicate a high probability of the pedestrian existing in the cell at a distance closer to 0.5 meters (based on the short-range map). Duplication of the pedestrian with different distance labels may help the perception model 217 to learn to differentiate between short-range and long-range pedestrians within the same cell 404. The perception model 217 may analyze the image features projected onto the cell and may predict existence probabilities in both channels (short-range 408 and long-range 406) based on the learned relationship between features and distances.

The disclosed ADAS system 203 may essentially have two object “detectors” within each cell 404. A short-range detector may be focused on detecting pedestrians within a shorter distance range (e.g., up to 50 meters based on the exemplary 0.5-meter cell resolution). A long-range detector may be focused on detecting pedestrians within a longer distance range (e.g., up to 100 meters based on the exemplary 1-meter cell resolution).

For pedestrians located within the overlapping range (between 0 and 50 meters in the aforementioned example), both detectors may activate and predict their existence. This may create a degree of redundancy.

The aforementioned redundancy may be beneficial. Such redundancy may increase the overall likelihood of detecting a pedestrian, especially in challenging scenarios with occlusions or difficult lighting conditions. The short-range detector, with its finer cell resolution (0.5 meters), offers better spatial resolution compared to the long-range detector (1-meter cell resolution). The higher spatial resolution may enable more precise localization of pedestrians, particularly important for accurate bounding box prediction and understanding pedestrian behavior (e.g., walking direction). The disclosed technique leverages the strengths of both short-range and long-range detection within a single grid cell 404. While there may be some redundancy for pedestrians within the overlapping range, this redundancy may provide a safety net for ensuring detection and offers more precise localization with the short-range detector.

Adding one channel may only slightly increase the number of calculations the perception 217 model needs to perform. The number of output channels in a BEV grid primarily affects the amount of data to be processed downstream but has a negligible impact on the overall computational cost of generating the BEV itself. By incorporating different resolutions within a single BEV grid, the perception model may cater to various perception tasks requiring different levels of detail without the need for multiple, independent BEV grids. The most computationally expensive part of the BEV generation process is typically the View Transform step, which projects sensor data onto the BEV grid. Using a single BEV grid with multiple resolutions may avoid performing this step multiple times, leading to significant computational savings. Keeping the overall number of output channels relatively low (12 in this case) may simplify the architecture of perception model 217 and may potentially make it easier to maintain and interpret the results. Overall, the benefits of a small runtime cost increase in this case may outweigh the potential drawbacks. The disclosed techniques enable implementation of the multi-distance grid cell strategy for improved pedestrian detection in dense environments without significantly compromising real-time processing capabilities. By employing a multi-range approach, the disclosed techniques effectively address the trade-off between high-resolution near-field perception (important for tasks like automated parking) and long-range object detection (important for collision avoidance). Single BEV grid with fixed resolution and range may limit flexibility for different perception tasks. Multi-range detection may allow for optimized BEV grids for specific tasks without compromising performance. One of the advantages of the disclosed techniques may be efficient utilization of computational resources. Another advantage may be improved accuracy for both near and far-field perception. As yet another advantage, the disclosed techniques may provide greater flexibility in adapting to different driving scenarios.

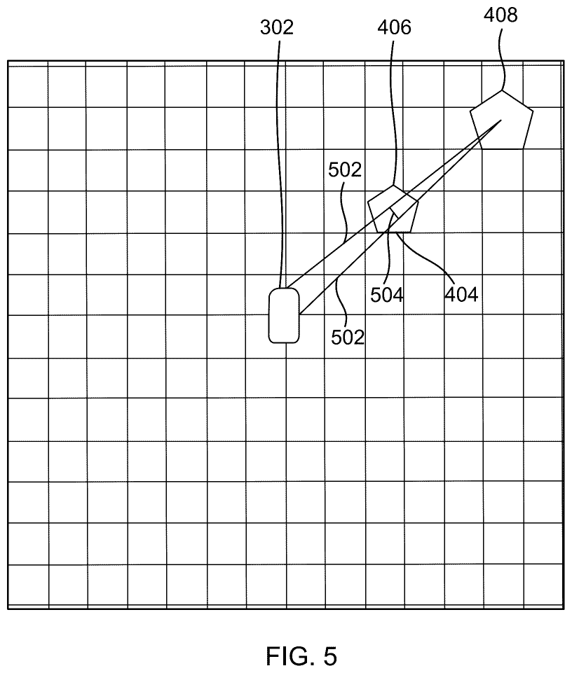

FIG. 5 is a diagram illustrating an angular error in accordance with the techniques of this disclosure. The ADAS system 203 uses a single grid for both short-range and long-range detection.

Misalignment of camera rays and grid cells may create a challenge: the “rays” 502 cast from the cameras of the vehicle 302 to project image features onto the grid cells 404 may not perfectly align with the cell boundaries, especially for long-range detections.

The aforementioned misalignment may lead to angular error 504 and reduced accuracy. The features may be projected onto slightly incorrect locations within the grid cell 404. For long-range detections 406, this angular error 504 may affect the accuracy of the “long-range existence” channel. It should be noted that the angular error 504 tends to decrease with distance. As camera rays 502 travel further, they become more parallel, reducing the mismatch with the grid cell boundaries. This implies that the long-range existence accuracy may actually improve with increasing distance from the vehicle 302.

To address the misalignment issue, the ADAS system 203 may use a post-processing filter. The filter may analyze the predicted “long-range existence” probabilities. In other words, the filter may filter out detections within a certain radius around the vehicle 302 (where the angular error 504 is likely higher). The effectiveness of the disclosed filter may depend on several factors, including, but not limited to: radius size and error distribution. The chosen radius for filtering needs to be large enough to exclude most inaccurate detections due to misalignment. However, the chosen radius should not be too large as to discard valid long-range detections where the error is minimal. Understanding the distribution of the angular error 504 across different distances may help determine the optimal filtering strategy.

Traditional approaches may require increasing the grid resolution or using more complex models to achieve a larger detection range.

The disclosed techniques achieve a similar goal (increased detection distance) without significantly increasing the model complexity or computational cost, because the disclosed ADAS system 203 may leverage a single grid 402 with multiple channels (short-range and long-range) instead of requiring a separate high-resolution grid. Adding one channel is a relatively inexpensive modification compared to other potential solutions. Advantageously, the ADAS system 203 may model each object (pedestrian in this case) with multiple channels in the ground truth. In other words, each channel may represent the existence probability of an object at a specific distance range. This may allow the perception model 217 to learn to differentiate between short-range and long-range objects within the same cell.

The output channels may have a pre-defined distance interpretation based on the channel itself. The disclosed techniques for flexible distance interpretation may allow the perception model 217 to use the same grid 402 for tasks with different distance requirements. For tasks requiring high-resolution detection (e.g., pedestrian pose estimation), the short-range channel 408 with finer resolution may be prioritized. For tasks requiring longer detection range (e.g., road boundary detection), the long-range channel 406 may be used. The disclosed techniques may achieve good detection distance without significant model complexity increase. The disclosed techniques leverage a single grid for multiple tasks with different distance needs. The disclosed techniques may adapt to varying distance requirements within the BEV representation.

The disclosed system may potentially detect pedestrians at a greater distance compared to a single-distance grid approach using the same number of cells. The use of a single grid 402 with multiple channels (short-range 408 and long-range 406) keeps the complexity of the perception model 217 and computational cost relatively low. Short-range detections may benefit from the original grid resolution, providing good detail for tasks like bounding box prediction. Since the same grid covers a larger area for long-range detection, each cell may represent a bigger portion of the real world. This may translate to lower spatial resolution for objects further away from the vehicle 302. The ADAS system 203 may prioritize maintaining good performance for short-range detections, critical for tasks like accurate pedestrian pose estimation and immediate safety decisions. For long-range detections, while the ADAS system 203 may provide existence probability and rough location, the finer details like precise pose or exact distance may be less accurate due to the limited resolution of the long-range channel.

Referring back to FIG. 4, in the ADAS system 203, both short-range 408 (0-50 meters) and long-range 406 (0-100 meters) detectors may share the same grid. This may lead to good spatial resolution for short-range detections due to the finer cell size representing a smaller real-world area. The illustrated techniques may also lead to lower spatial resolution for long-range detections as each cell may cover a larger portion of the real world.

In one implementation, the ADAS system 203 may start the long-range detection channel at the upper limit of the short-range channel (i.e., 50 meters in this example). This may essentially create a “gap” between the two channels. Objects within 0-50 meters would be mapped only to the short-range channel 408 (with higher resolution). Objects within 50-100 meters would be mapped only to the long-range channel 406 (covering the additional range). Since the long-range channel 406 may now cover a smaller distance (50-100 meters) with the same number of cells, the spatial resolution for long-range objects may potentially improve. Each object may be mapped to only one detection channel based on its distance, potentially simplifying the interpretation of the perception model 217. There may still be some ambiguity for objects located exactly at 50 meters. Both channels may have some activation depending on the training of the perception model 217. If an object is very small and spans the 50-meter boundary, that object may be missed by both channels due to the gap. This requires careful consideration depending on the specific application. The optimal gap size between the two channels may not be exactly the same as the range overlap (50 meters in this case). It may be beneficial to experiment with different gap sizes to find the best balance between resolution and coverage.

A Cartesian grid, like grid 402 illustrated in FIG. 4, may represent space with fixed-size cells. Each cell may correspond to a specific real-world distance in both horizontal and vertical directions. Introducing a gap between detection channels solely based on distance (e.g., 0-50 meters for short-range and 50-100 meters for long-range) may not align perfectly with the grid cells 404. Objects located at the boundary between the gap (e.g., 50 meters) may fall within a single cell that overlaps both short-range and long-range coverage. However, misaligned boundaries may create ambiguity for the perception model 217. The object may activate both channels with uncertain probability due to its position within the cell. In the worst case, the object may be missed by both channels if it falls exactly on the boundary between cells. The challenges may become even more complex when considering objects with diagonal movement. The distance an object may travel diagonally across a cell may not correspond exactly to either the horizontal or vertical distance represented by the cell. Diagonal movement may lead to further misalignment issues and potential information loss.

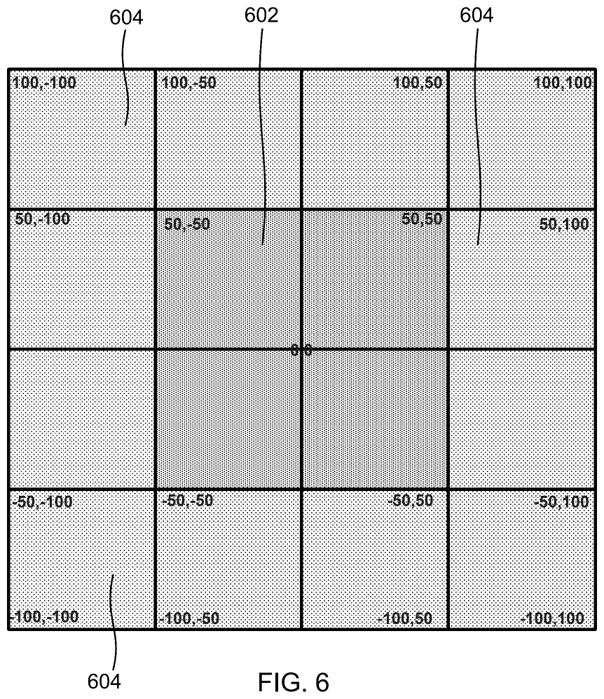

FIG. 6 is a diagram illustrating misalignment issues of a Cartesian grid in accordance with the techniques of this disclosure. FIG. 6 illustrates the problem with the first region 602 representing the short-range detection area and the second region 604 representing the long-range detection area. Simply shrinking the first region 602 to a single point (0,0) to eliminate the gap, may lead to the second region 604 (long-range) abruptly starting at the edges, creating a discontinuity.

In a Cartesian coordinate system, cells have fixed sizes. Shrinking the first region 602 in one dimension (say, width) would not automatically shrink it in the other dimension (height) to maintain a continuous boundary.

As noted above, the aforementioned challenges may lead to inconsistencies in how objects are mapped to channels based on their location within a cell that overlaps both short-range and long-range coverage.

A principle of Cartesian grids is that they have fixed cell sizes. Each cell may represent a specific area in the real world, defined by both its width and height. Shrinking the short-range detection area (represented by the first region 602) to a single point (0,0) only affects its width or height dimension. In a Cartesian system, shrinking one dimension of a cell would not automatically shrink the other dimension. This creates a mismatch. In one example, shrinking the short-range area to a point while maintaining a fixed size for the long-range area may introduce a discontinuity at the boundary. Objects located at the edge of the shrunk short-range area would not have a clear channel mapping. These objects may fall within a single cell that overlaps both short-range and long-range coverage, leading to confusion for the perception model 217.

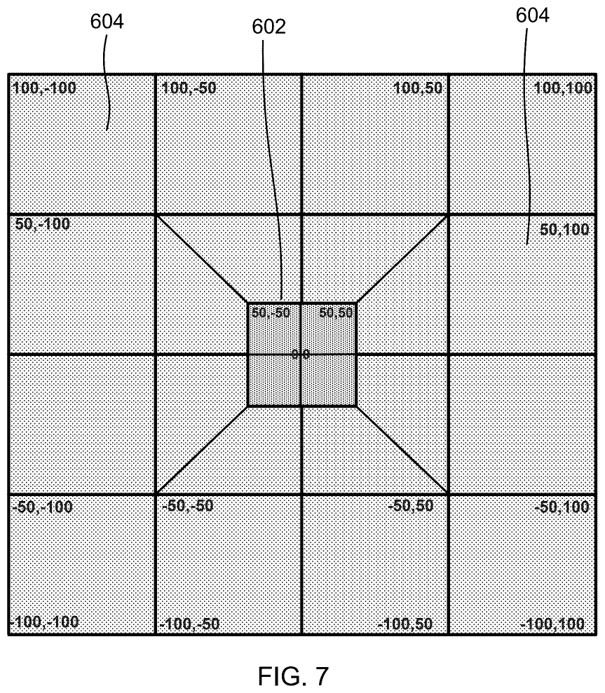

FIG. 7 illustrates that in a Cartesian system shrinking one dimension of a cell while maintaining the other may create discontinuity at the boundary between short-range and long-range detection areas in accordance with the techniques of this disclosure.

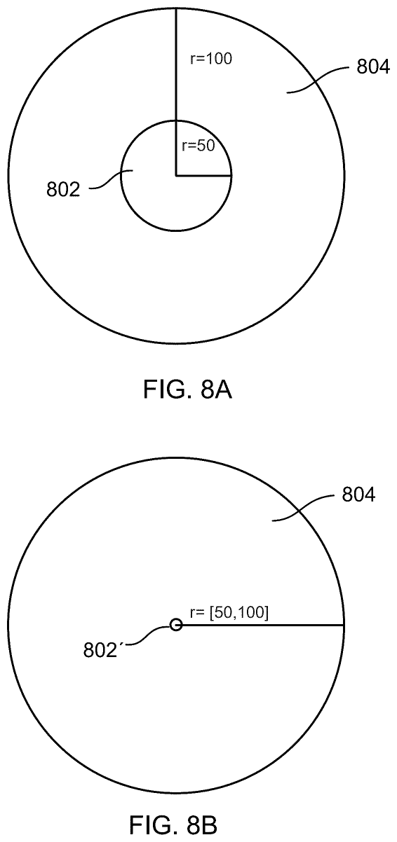

FIG. 8A is a diagram illustrating representation of detection areas using a polar coordinate system in accordance with techniques of this disclosure. A polar coordinate system represents space using distance (radius) and angle (theta). In this case, setting the radius to 0 for the short-range detection area 802 effectively collapses it to a single point (0,0) 802′ at the center, as shown in FIG. 8B. The long-range detection area 804 may utilize the full range of radii from 50 meters to 100 meters, maintaining full resolution for this entire range. The transition between short-range and long-range detection becomes more natural as the radius increases from 0 outwards. FIG. 8B illustrates distances of 50 meters and 100 meters for short-range and long-range detection, respectively. However, to achieve the same average spatial resolution across both ranges, a simple radius increase from 50 meters to 100 meters would not suffice.

A polar coordinate system relies on the concept of area enclosed by a circle. The area of a circle is calculated by π*radius². Simply doubling the radius from 50 meters to 100 meters quadruples the area covered (4 times larger). To achieve the same average spatial resolution across both ranges, the long-range area 804 should be only twice the size of the short-range area 802. For illustrative purposes assume the short-range radius (representing the area for short-range detection 802) is 50 meters (as in the above example). The long-range area 804 should be twice the size of the short-range area 802. To achieve this, the long-range radius needs to be the square root of 2 times the short-range radius. Mathematically, long-range radius=\sqrt{(2)*Short range radius}=\sqrt{(2)*50 meters}≈70.7 meters (approximately). Therefore, in the example illustrated in FIG. 8A, to have the same average spatial resolution across detection ranges using a polar coordinate system, a more accurate representation would be: short-range detection: 0 to 50 meters; long-range detection: 50 meters to approximately 70.7 meters (or it can be rounded to 71 meters for simplicity). By adjusting the long-range radius based on area considerations, the ADAS 203 may ensure that both detection ranges contribute equally to the overall spatial resolution of the system. This may provide a more balanced representation for pedestrian detection in vehicle. The chosen discretization (number of bins) for the angle (theta) in the polar coordinate system may also impact the effective resolution. A finer discretization may be beneficial for maintaining good angular resolution. The actual impact of this adjustment on a specific application may depend on the importance of having a perfectly equal average resolution across both ranges. In some cases, a close approximation (like 71 meters) may be sufficient. Unlike the techniques described above with a single grid, the polar coordinates techniques may allow to keep adding new discs with larger radii to extend the detection range without compromising the spatial resolution within each disc.

Similar to the Cartesian coordinates techniques illustrated in FIGS. 4 and 5, the polar coordinates techniques illustrated in FIGS. 8A and 8B may use a single model with multiple channels, maintaining computational efficiency. By dividing the short-range detection into multiple discs (each representing a smaller radius interval), the ADAS 203 may effectively increase the spatial resolution for objects closer to the vehicle 302. This provides more granular detail for tasks like pedestrian pose estimation. Advantageously, the disclosed techniques provide a scalable detection range.

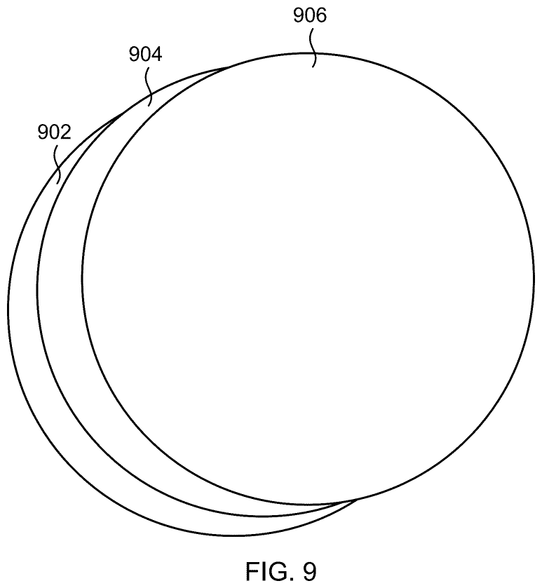

FIG. 9 is a diagram of extendable detection range in accordance with the techniques of this disclosure, The detection range can be extended as needed by adding more discs 902-906. Tailoring disc sizes may allow for adjusting resolution within specific ranges. The core Multi-Distance Detection (MDD) concept of a single model with multiple channels keeps the system computationally efficient. Determining the optimal number of discs 902-906 for both short and long range may depend on the desired resolution granularity and computational constraints. More discs 902-906 may lead to finer resolution but may increase processing time. There may be a slight overlap between adjacent discs to ensure smooth transitions in detection probability across the range boundaries. The ground truth data for training the model may need to be adapted to the disc-based approach. Each disc 902-906 would require labels for object existence probability within its specific radius interval. The disclosed techniques may be potentially applied to other tasks beyond pedestrian detection, such as object classification or obstacle detection, where both long detection range and high resolution for nearby objects are important.

Due to the overlap between channels (discs 902-906) representing different detection ranges, the ADAS system 203 may need more capacity for data movement because the perception model 217 may need to consider information from potentially multiple channels for any given location in the image. The overlapping channels may make the problem slightly harder to train for the ADAS system 203. The disclosed techniques rely on a polar coordinate system for proper disc-based representation. Polar coordinates may provide a natural way to represent detection ranges with discs 902-906, eliminating discontinuity issues faced with Cartesian grids. While output channels themselves may have minimal computational overhead, increasing their number may impact data transfer between the accelerator and other processing units. The impact on training time may be less clear. Increasing the number of properties may potentially increase convergence time, but this is not guaranteed. The impact could also depend on the specific architecture and training data. Replicating the entire set of properties for each detection range may effectively reduce channel overlap, potentially improving the ability of the perception model 217 to distinguish between objects at different distances.

The aforementioned techniques that relied on a single grid 402 system for all detection ranges limited the ability to achieve both high spatial resolution for short distances and long detection range simultaneously. The techniques illustrated in FIGS. 8A, 8B and 9 introduce a polar coordinate system with equi-areal discs 902-906 representing different detection ranges. Each disc 902-906 may cover a specific area around the vehicle. Unlike techniques illustrated in FIGS. 4 and 5, these techniques allow adding new discs 902-906 with larger radii to extend the detection range as needed. By adjusting the size and number of discs 902-906, the spatial resolution may be tailored within specific ranges. Smaller discs closer to the vehicle may provide higher resolution for detailed object detection, while larger discs may cover wider areas for long-range detection. Both techniques use a single model with multiple channels (one for each disc). This maintains computational efficiency compared to alternative approaches requiring multiple models.

It should be noted that both spatial resolution and detection distance may be scaled arbitrarily by adding or adjusting discs 902-906. This provides a highly flexible system adaptable to different needs. Compared to approaches requiring additional models or hardware for increased range or resolution, the disclosed techniques may achieve scaling in a cost effective manner by simply adjusting the disc configuration within the same model framewok. In summary, the disclosed techniques may parametrize the area around the vehicle using equi-areal discs 902-906 in a polar coordinate system. The disclosed techniques enable a more efficient and scalable solution for MDD compared to the conventional approaches. The disclosed techniques may require transforming image data from a Cartesian camera view to a polar grid, which may introduce some additional processing overhead. The architecture of ADAS 203 may need to be adapted to handle overlapping data from multiple discs representing different detection ranges. Training the perception model 217 with overlapping channels may require specific techniques like data augmentation and appropriate loss functions.

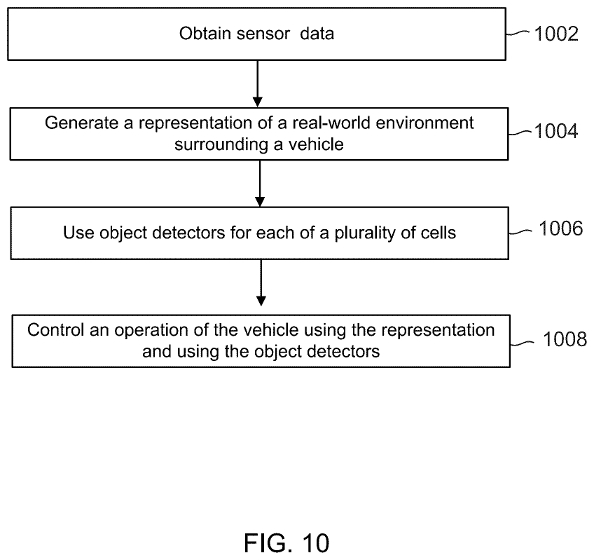

FIG. 10 is a flowchart illustrating an example method for sensing in accordance with the techniques of this disclosure. Although described with respect to computing system 200 (FIG. 2), it should be understood that other computing devices may be configured to perform a method similar to that of FIG. 10.

ADAS 203 may obtain sensor data generated by one or more sensors of a vehicle (1002). ADAS 203 may generate a representation of at least a portion of a real-world environment surrounding the vehicle based on the sensor data (1004). The representation of the real-world environment surrounding the vehicle may include a grid having a plurality of cells. At least some of the plurality of cells may simultaneously correspond to multiple real-world distances from the vehicle. Advantageously, ADAS 203 may model each object (pedestrian, for example) with multiple channels in the ground truth. In other words, each channel may represent the existence probability of an object at a specific distance range. This may allow the perception model 217 to learn to differentiate between short-range and long-range objects within the same cell. ADAS 203 may use a plurality of object detectors for each of the plurality of cells. Each of the plurality of object detectors may correspond to a pre-defined real-world distance range from the vehicle (1006). ADAS 203 may control an operation of the vehicle using the representation and the plurality of object detectors (1008).

Thus, the techniques of this disclosure are directed to representing object existence at different distances within a single data structure. Traditionally, ADAS systems may use separate grids or maps to represent objects at different distances. This can be inefficient due to having to perform multiple view transform operations. The disclosed techniques use a single grid in a Cartesian coordinate system with multiple channels to represent object existence at different distances simultaneously. Essentially, the grid cells and depth bins may correspond to multiple distances simultaneously.

The following numbered clauses illustrate one or more aspects of the devices and techniques described in this disclosure.
Clause 1. A method for sensing includes obtaining sensor data generated by one or more sensors of a vehicle; generating a representation of at least a portion of a real-world environment surrounding the vehicle based on the sensor data, wherein the representation of the real-world environment surrounding the vehicle comprises a grid having a plurality of cells and wherein a first cell of the plurality of cells corresponds to a first real-world distance between the real-world environment and the vehicle and a second real-world distance between the real-world environment and the vehicle, and wherein at least a second cell of the plurality of cells corresponds to a third real-world distance between the real-world environment and the vehicle and a fourth real-world distance between the real-world environment and the vehicle; using a plurality of object detectors for each of the plurality of cells, wherein each of the plurality of object detectors corresponds to a pre-defined real-world distance range from the vehicle; and controlling an operation of the vehicle using the representation and the plurality of object detectors.
Clause 2—The method of clause 1, wherein generating the representation further comprises generation of a plurality of depth bins based on the sensor data and wherein controlling the operation of the vehicle further comprises one or more of: detecting one or more objects in the environment surrounding the vehicle based on the plurality of cells; and estimating a depth of one or more objects in the environment surrounding the vehicle based on the plurality of depth bins, wherein a first bin of the plurality of depth bins corresponds to a first real-world distance between the real-world environment and the vehicle and a second real-world distance between the real-world environment and the vehicle, and wherein at least a second depth bin of the plurality of depth bins corresponds to a third real-world distance between the real-world environment and the vehicle and a fourth real-world distance between the real-world environment and the vehicle.
Clause 3—The method of clause 1, wherein the representation is generated using polar coordinates, and wherein the representation comprises one or more discs.
Clause 4—The method of clause 3, further comprising: adjusting spatial resolution of the representation by changing a size or number of the one or more discs.
Clause 5—The method of any of clauses 1-4, wherein the representation comprises a plurality of channels.
Clause 6—The method of clause 5, wherein at least one of the plurality of channels represents a probability of an object at a specific distance range.
Clause 7—The method of any of clauses 1-6, wherein controlling the operation of the vehicle further comprises navigating the vehicle using the representation and the plurality of object detectors.
Clause 8—The method of any of clauses 1-6, wherein controlling the operation of the vehicle further comprises planning a travel path for the vehicle using the representation and the plurality of object detectors.
Clause 9—The method of any of clauses 1-6, wherein controlling an operation of the vehicle further comprises controlling an operation an Advanced Driver Assistance Systems (ADAS) using the representation and the plurality of object detectors.
Clause 10. An apparatus for sensing, the apparatus comprising: a memory for storing sensor data; and processing circuitry in communication with the memory, wherein the processing circuitry is configured to: obtain the sensor data generated by one or more sensors of a vehicle; generate a representation of at least a portion of a real-world environment surrounding the vehicle based on the sensor data, wherein the representation of the real-world environment surrounding the vehicle comprises a grid having a plurality of cells and wherein a first cell of the plurality of cells corresponds to a first real-world distance between the real-world environment and the vehicle and a second real-world distance between the real-world environment and the vehicle, and wherein at least a second cell of the plurality of cells corresponds to a third real-world distance between the real-world environment and the vehicle and a fourth real-world distance between the real-world environment and the vehicle; use a plurality of object detectors for each of the plurality of cells, wherein each of the plurality of object detectors corresponds to a pre-defined real-world distance range from the vehicle; and control an operation of the vehicle using the representation and the plurality of object detectors.
Clause 11—The apparatus of clause 10, wherein the processing circuitry configured to generate the representation is further configured to generate of a plurality of depth bins based on the sensor data and wherein the processing circuitry configured to control the operation of the vehicle is further configured to one or more of: detect one or more objects in the environment surrounding the vehicle based on the plurality of cells; and estimate a depth of one or more objects in the environment surrounding the vehicle based on the plurality of depth bins, wherein a first bin of the plurality of depth bins corresponds to a first real-world distance between the real-world environment and the vehicle and a second real-world distance between the real-world environment and the vehicle, and wherein at least a second depth bin of the plurality of depth bins corresponds to a third real-world distance between the real-world environment and the vehicle and a fourth real-world distance between the real-world environment and the vehicle.
Clause 12—The apparatus of clause 10, wherein the representation is generated using polar coordinates, and wherein the representation comprises one or more discs.
Clause 13—The apparatus of clause 12, wherein the processing circuitry is further configured to: adjust spatial resolution of the representation by changing a size or number of the one or more discs.
Clause 14—The apparatus of any of clauses 10-13, wherein the representation comprises a plurality of channels.
Clause 15—The apparatus of clause 14, wherein at least one of the plurality of channels represents a probability of an object at a specific distance range.
Clause 16—The apparatus of any of clauses 10-15, wherein the processing circuitry configured to control the operation of the vehicle is further configured to: navigate the vehicle using the representation and the plurality of object detectors.
Clause 17—The apparatus of any of clauses 10-15, wherein the processing circuitry configured to control the operation of the vehicle is further configured to: plan a travel path for the vehicle using the representation and the plurality of object detectors.
Clause 18—The apparatus of any of clauses 10-15, wherein the processing circuitry configured to control the operation of the vehicle is further configured to: control an operation an Advanced Driver Assistance Systems (ADAS) using the representation and the plurality of object detectors.
Clause 19—Non-transitory computer-readable storage media having instructions encoded thereon, the instructions configured to cause processing circuitry to: obtain the sensor data generated by one or more sensors of a vehicle; generate a representation of at least a portion of a real-world environment surrounding the vehicle based on the sensor data, wherein the representation of the real-world environment surrounding the vehicle comprises a grid having a plurality of cells and wherein a first cell of the plurality of cells corresponds to a first real-world distance between the real-world environment and the vehicle and a second real-world distance between the real-world environment and the vehicle, and wherein at least a second cell of the plurality of cells corresponds to a third real-world distance between the real-world environment and the vehicle and a fourth real-world distance between the real-world environment and the vehicle; use a plurality of object detectors for each of the plurality of cells, wherein each of the plurality of object detectors corresponds to a pre-defined real-world distance range from the vehicle; and control an operation of the vehicle using the representation and the plurality of object detectors.
Clause 20—The non-transitory computer-readable storage media of clause 19, wherein the instructions configured to cause the processing circuitry to generate the representation are further configured to generate of a plurality of depth bins based on the sensor data and wherein the instructions configured to cause the processing circuitry to control the operation of the vehicle are further configured to one or more of: detect one or more objects in the environment surrounding the vehicle based on the plurality of cells; and estimate a depth of one or more objects in the environment surrounding the vehicle based on the plurality of depth bins, wherein a first bin of the plurality of depth bins corresponds to a first real-world distance between the real-world environment and the vehicle and a second real-world distance between the real-world environment and the vehicle, and wherein at least a second depth bin of the plurality of depth bins corresponds to a third real-world distance between the real-world environment and the vehicle and a fourth real-world distance between the real-world environment and the vehicle.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of random-access memory (RAM), read-only memory (ROM), electrically erasable ROM (EEPROM), compact disc ROM (CD-ROM) or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for sensing comprising:
obtaining sensor data generated by one or more sensors of a vehicle;
generating a representation of at least a portion of a real-world environment surrounding the vehicle based on the sensor data, wherein the representation of the real-world environment surrounding the vehicle comprises a grid having a plurality of cells and wherein a first cell of the plurality of cells corresponds to a first real-world distance between the real-world environment and the vehicle and a second real-world distance between the real-world environment and the vehicle, and wherein at least a second cell of the plurality of cells corresponds to a third real-world distance between the real-world environment and the vehicle and a fourth real-world distance between the real-world environment and the vehicle;
using a plurality of object detectors for each of the plurality of cells, wherein each of the plurality of object detectors corresponds to a pre-defined real-world distance range from the vehicle; and
controlling an operation of the vehicle using the representation and the plurality of object detectors.

2. The method of claim 1, wherein generating the representation further comprises generation of a plurality of depth bins based on the sensor data and wherein controlling the operation of the vehicle further comprises one or more of:
detecting one or more objects in the environment surrounding the vehicle based on the plurality of cells; and
estimating a depth of one or more objects in the environment surrounding the vehicle based on the plurality of depth bins, wherein a first bin of the plurality of depth bins corresponds to a first real-world distance between the real-world environment and the vehicle and a second real-world distance between the real-world environment and the vehicle, and wherein at least a second depth bin of the plurality of depth bins corresponds to a third real-world distance between the real-world environment and the vehicle and a fourth real-world distance between the real-world environment and the vehicle.

3. The method of claim 1, wherein the representation is generated using polar coordinates, and wherein the representation comprises one or more discs.

4. The method of claim 3, further comprising:
adjusting spatial resolution of the representation by changing a size or number of the one or more discs.

5. The method of claim 1, wherein the representation comprises a plurality of channels.

6. The method of claim 5, wherein at least one of the plurality of channels represents a probability of an object at a specific distance range.

7. The method of claim 1, wherein controlling the operation of the vehicle further comprises navigating the vehicle using the representation and the plurality of object detectors.

8. The method of claim 1, wherein controlling the operation of the vehicle further comprises planning a travel path for the vehicle using the representation and the plurality of object detectors.

9. The method of claim 1, wherein controlling an operation of the vehicle further comprises controlling an operation an Advanced Driver Assistance Systems (ADAS) using the representation and the plurality of object detectors.

10. An apparatus for sensing, the apparatus comprising:
a memory for storing sensor data; and
processing circuitry in communication with the memory, wherein the processing circuitry is configured to:
obtain the sensor data generated by one or more sensors of a vehicle;
generate a representation of at least a portion of a real-world environment surrounding the vehicle based on the sensor data, wherein the representation of the real-world environment surrounding the vehicle comprises a grid having a plurality of cells and wherein a first cell of the plurality of cells corresponds to a first real-world distance between the real-world environment and the vehicle and a second real-world distance between the real-world environment and the vehicle, and wherein at least a second cell of the plurality of cells corresponds to a third real-world distance between the real-world environment and the vehicle and a fourth real-world distance between the real-world environment and the vehicle;
use a plurality of object detectors for each of the plurality of cells, wherein each of the plurality of object detectors corresponds to a pre-defined real-world distance range from the vehicle; and
control an operation of the vehicle using the representation and the plurality of object detectors.

11. The apparatus of claim 10, wherein the processing circuitry configured to generate the representation is further configured to generate of a plurality of depth bins based on the sensor data and wherein the processing circuitry configured to control the operation of the vehicle is further configured to one or more of:
detect one or more objects in the environment surrounding the vehicle based on the plurality of cells; and
estimate a depth of one or more objects in the environment surrounding the vehicle based on the plurality of depth bins, wherein a first bin of the plurality of depth bins corresponds to a first real-world distance between the real-world environment and the vehicle and a second real-world distance between the real-world environment and the vehicle, and wherein at least a second depth bin of the plurality of depth bins corresponds to a third real-world distance between the real-world environment and the vehicle and a fourth real-world distance between the real-world environment and the vehicle.

12. The apparatus of claim 10, wherein the representation is generated using polar coordinates, and wherein the representation comprises one or more discs.

13. The apparatus of claim 12, wherein the processing circuitry is further configured to:
adjust spatial resolution of the representation by changing a size or number of the one or more discs.

14. The apparatus of claim 10, wherein the representation comprises a plurality of channels.

15. The apparatus of claim 14, wherein at least one of the plurality of channels represents a probability of an object at a specific distance range.

16. The apparatus of claim 10, wherein the processing circuitry configured to control the operation of the vehicle is further configured to:
navigate the vehicle using the representation and the plurality of object detectors.

17. The apparatus of claim 10, wherein the processing circuitry configured to control the operation of the vehicle is further configured to:
plan a travel path for the vehicle using the representation and the plurality of object detectors.

18. The apparatus of claim 10, wherein the processing circuitry configured to control the operation of the vehicle is further configured to:
control an operation an Advanced Driver Assistance Systems (ADAS) using the representation and the plurality of object detectors.

19. Non-transitory computer-readable storage media having instructions encoded thereon, the instructions configured to cause processing circuitry to:
obtain sensor data generated by one or more sensors of a vehicle;
generate a representation of at least a portion of a real-world environment surrounding the vehicle based on the sensor data, wherein a first cell of the plurality of cells corresponds to a first real-world distance between the real-world environment and the vehicle and a second real-world distance between the real-world environment and the vehicle, and wherein at least a second cell of the plurality of cells corresponds to a third real-world distance between the real-world environment and the vehicle and a fourth real-world distance between the real-world environment and the vehicle;
use a plurality of object detectors for each of the plurality of cells, wherein each of the plurality of object detectors corresponds to a pre-defined real-world distance range from the vehicle; and
control an operation of the vehicle using the representation and the plurality of object detectors.

20. The non-transitory computer-readable storage media of claim 19, wherein the instructions configured to cause the processing circuitry to generate the representation are further configured to generate of a plurality of depth bins based on the sensor data and wherein the instructions configured to cause the processing circuitry to control the operation of the vehicle are further configured to one or more of:
detect one or more objects in the environment surrounding the vehicle based on the plurality of cells; and
estimate a depth of one or more objects in the environment surrounding the vehicle based on the plurality of depth bins, wherein a first bin of the plurality of depth bins corresponds to a first real-world distance between the real-world environment and the vehicle and a second real-world distance between the real-world environment and the vehicle, and wherein at least a second depth bin of the plurality of depth bins corresponds to a third real-world distance between the real-world environment and the vehicle and a fourth real-world distance between the real-world environment and the vehicle.
